(19) United States
(12) Patent Application Publication
(10) Pub. No.: US 2026/0203964 A1
(43) Pub. Date: Jul. 16, 2026

(54) DATA LARGE-SCREEN PAGE PROCESSING METHOD AND APPARATUS, AND RELATED DEVICE

(71) Applicant: Beijing Volcano Engine Technology Co., Ltd., Beijing (CN)

(72) Inventors: Pei LIU, Beijing (CN); Wenhai YANG, Beijing (CN); Xuan LUO, Beijing (CN)

(21) Appl. No.: 19/132,238

(22) PCT Filed: Mar. 21, 2024
(86) PCT No.: PCT/CN2024/082929

§ 371 Date: May 22, 2025

(30) Foreign Application Priority Data
Mar. 22, 2023 (CN) 202310287609.0

(51) Int. Cl. G06T 11/10; G06T 11/26

(52) U.S. Cl. CPC G06T 11/10; G06T 11/26

(57) ABSTRACT

A data large-screen page processing method, an apparatus and related devices. The method includes: obtaining a to-be-colored data large-screen page, component information of the to-be-colored data large-screen page, and a preset color palette, where the to-be-colored data large-screen page includes to-be-colored components, the component information includes a component type of each to-be-colored component, and the preset color palette includes one or more basic colors; determining a target color of a target component based on a component type of the target component, where the target component is one of the to-be-colored components included in the to-be-colored data large-screen page, and the target color is determined based on one or more colors selected from a group consisting of the preset color palette and a background color of the to-be-colored data large-screen page; and coloring the target component with the target color to obtain a colored data large-screen page.

The present application claims priority to Chinese Patent Application No. 202310287609.0, filed on Mar. 22, 2023, the disclosure of which is hereby incorporated by reference in its entirety as part of the present application.

### TECHNICAL FIELD

The present disclosure relates to a data large-screen page processing method, an apparatus and related devices.

### BACKGROUND

In a scenario involving data display, a data large-screen device is usually used to display data. The data large-screen device is a device with a large display screen for displaying data. A data large-screen editing platform can edit the data large-screen and provide a data visualization service. Users can freely drag and drop visual components such as data charts, graphics, and controls provided by the data large-screen editing platform to implement configuration and layout of the data large-screen. In this way, users can easily build a visual data large-screen without programming, and freely determine a size of the data large-screen based on a resolution of the data large-screen device. The data large-screen is further configured with display manners such as a three-dimensional map and a transition animation. The users configure the display manners, so that the data displayed on the data large-screen has dynamic expressiveness, and there is a conspicuous animation reminder when the data is updated or changed, which facilitates the users to display the data. The users can realize a walk-through narration in an exhibition hall based on the data large-screen displayed by the data large-screen device, and can also present data based on the data large-screen displayed by the data large-screen device.

In a process of editing, by a user, a data large-screen page to be displayed by a data large-screen device, the user needs to manually configure the color for the data large-screen page according to a requirement of displayed content, resulting in low efficiency of coloring the data large-screen page.

### SUMMARY

In view of this, the present disclosure provides a data large-screen page processing method, an apparatus, and related devices, which can improve coloring efficiency of a data large-screen page.

To solve the above problem, the technical solutions provided by the present disclosure are as follows:

Based on this, the technical solutions provided by the present disclosure are as follows:

In a first aspect, the present disclosure provides a data large-screen page processing method, the method includes:
obtaining a to-be-colored data large-screen page, component information of the to-be-colored data large-screen page, and a preset color palette, where the to-be-colored data large-screen page includes to-be-colored components, the component information includes a component type of each to-be-colored component, and the preset color palette includes one or more basic colors;
determining a target color of a target component based on a component type of the target component, where the target component is one of the to-be-colored components included in the to-be-colored data large-screen page, and the target color is determined based on one or more colors selected from a group consisting of the preset color palette and a background color of the to-be-colored data large-screen page; and
coloring the target component with the target color to obtain a colored data large-screen page.

In a second aspect, the present disclosure provides a data large-screen page processing apparatus, the apparatus includes:
an obtaining unit, configured to obtain a to-be-colored data large-screen page, component information of the to-be-colored data large-screen page, and a preset color palette, where the to-be-colored data large-screen page includes to-be-colored components, the component information includes a component type of each to-be-colored component, and the preset color palette includes one or more basic colors;
a determining unit, configured to determine a target color of a target component based on a component type of the target component, where the target component is one of the to-be-colored components included in the to-be-colored data large-screen page, and the target color is determined based on one or more colors selected from a group consisting of the preset color palette and a background color of the to-be-colored data large-screen page; and
a coloring unit, configured to color the target component with the target color to obtain a colored data large-screen page.

In a third aspect, the present disclosure provides an electronic device, the electronic device includes:
one or more processors; and
a storage apparatus, configured to store one or more programs,
where the one or more programs, when executed by the one or more processors, cause the one or more processors to implement the method according to any one of the first aspect.

In a fourth aspect, the present disclosure provides a computer-readable medium, configured to store a computer program, where the computer program, when executed by a processor, causes the processor to implement the method according to any one of the first aspect.

In a fifth aspect, the present disclosure provides a computer program product, where the computer program product, when running on a device, causes the device to implement the method according to the first aspect.

### BRIEF DESCRIPTION OF DRAWINGS

FIG. 1 is a schematic diagram of a framework of an exemplary application scenario provided by an embodiment of the present disclosure;

FIG. 2 is a flowchart of a data large-screen page processing method provided by an embodiment of the present disclosure;

FIG. 3 is a schematic diagram of a data large-screen page provided by an embodiment of the present disclosure;

FIG. 4 is a schematic diagram of a structure of a data large-screen page processing apparatus provided by an embodiment of the present disclosure; and

FIG. 5 is a schematic diagram of a basic structure of an electronic device provided by an embodiment of the present disclosure.

### DETAILED DESCRIPTION

To facilitate understanding and explanation of the technical solutions provided by the embodiments of the present disclosure, the background of the present disclosure will be described first below.

A user who creates a data large-screen page usually calls a component to edit content to be displayed. To enhance a viewing experience of a viewer, the user who creates the data large-screen page configures corresponding color for components included in the data large-screen page. At present, the user manually configures the color of the components in the data large-screen page based on the user's experience of editing the data large-screen page, resulting in low efficiency of color matching for the data large-screen page.

Based on this, the embodiments of the present disclosure provide a data large-screen page processing method, an apparatus, a device, and a storage medium. In the method, a to-be-colored data large-screen page, component information of the to-be-colored data large-screen page, and a preset color palette are first obtained, where the to-be-colored data large-screen page includes to-be-colored components, the component information includes a component type of each to-be-colored component, and the preset color palette includes one or more basic colors; a target color of a target component is determined by using a color matching method corresponding to the component type of the target component, where the target component is one of the to-be-colored components included in the to-be-colored data large-screen page, and the target color of the target component is determined based on one or more colors selected from a group consisting of the preset color palette and a background color of the to-be-colored data large-screen page; and then the target component is colored with the target color to obtain a colored data large-screen page. In this way, the target color of the component can be determined based on the component type of the component included in the data large-screen page, and automatic coloring of the component can be implemented, which can improve efficiency of coloring the data large-screen page.

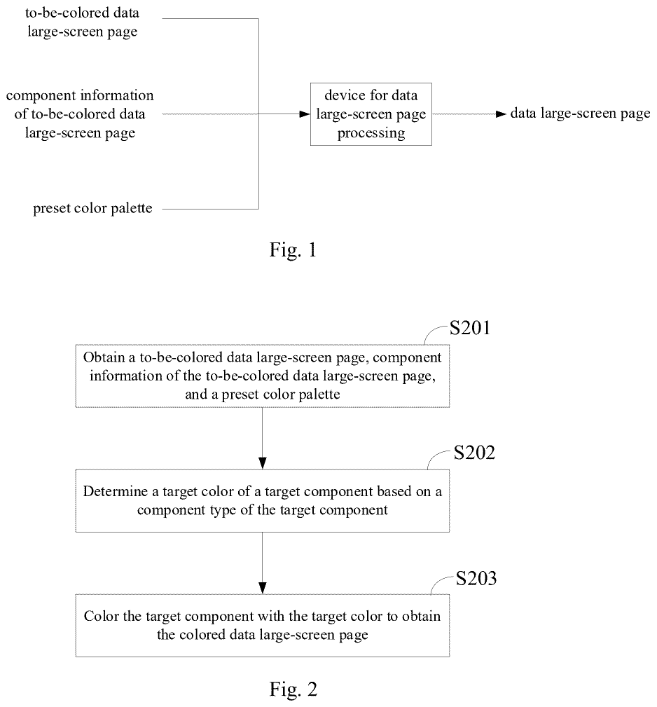

To facilitate understanding of a data large-screen page processing method provided by the embodiments of the present disclosure, a data large-screen page processing method provided by the embodiments of the present disclosure will be described below with reference to the drawings, and will be described below with reference to the scenario example shown in FIG. 1. Referring to FIG. 1, this figure is a schematic diagram of a framework of an exemplary application scenario provided by an embodiment of the present disclosure.

In practical applications, the user inputs the to-be-colored data large-screen page for which content editing is completed, the component information of the to-be-colored data large-screen page, and the preset color palette including the selected basic color for coloring to the device for data large-screen page processing. The component information of the to-be-colored data large-screen page may be obtained by pre-analyzing components of the to-be-colored data large-screen page, or may be obtained based on editing data of the user editing the data large-screen page. The component information includes the component type of each to-be-colored component of the to-be-colored data large-screen page. The device for data large-screen page processing then colors the to-be-colored component according to the target color, to obtain the data large-screen page that is completely colored.

It should be noted that the device for data large-screen page processing may be a device that provides the user with a data large-screen page processing service, such as a server. The user can access and use the data large-screen page processing service provided by the server through a client or a page configured on a terminal device. The device for data large-screen page processing may also be a terminal device such as a computer. The terminal device is pre-configured with a program that implements data large-screen page processing. The user can use the program that implements the data large-screen page processing to implement coloring of the data large-screen page.

Those skilled in the art can understand that the schematic diagram of the framework shown in FIG. 1 is only an example in which the implementations of the present disclosure can be implemented. The scope of the implementations of the present disclosure is not limited by any aspect of the framework.

To facilitate understanding of the technical solutions provided by the embodiments of the present disclosure, the data large-screen page processing method provided by the embodiments of the present disclosure is described below with reference to the drawings.

Referring to FIG. 2, which is a flowchart of a data large-screen page processing method provided by an embodiment of the present disclosure, as shown in FIG. 2, the method may include S201-S203.
S201: Obtain a to-be-colored data large-screen page, component information of the to-be-colored data large-screen page, and a preset color palette.

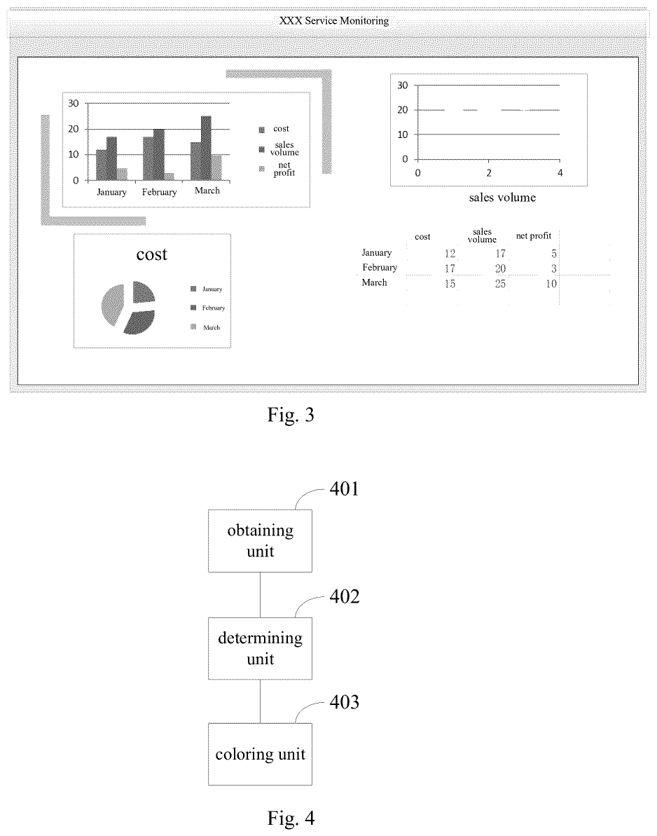

The to-be-colored data large-screen page is a page that needs to be colored and is obtained after the user edits content of the data large-screen page. Referring to FIG. 3, which is a schematic diagram of a data large-screen page provided by an embodiment of the present disclosure. The to-be-colored data large-screen page includes to-be-colored components. The to-be-colored component is, for example, a chart, text, data, and a decorative image included in the to-be-colored data large-screen page. Taking the to-be-colored data large-screen page shown in FIG. 3 as an example, the to-be-colored components includes a title text “XXX business monitoring”, a bar chart, a pie chart, a bubble chart, a decorative border, and a table.

The to-be-colored component may have an initial color. The initial color is, for example, an original color configured for the to-be-colored component, or a neutral color. The neutral color includes white, black, and gray. The to-be-colored data large-screen page has a background color. In the embodiment of the present disclosure, the background color is preset by the user, or is a default background color of the data large-screen page.

The component information of the to-be-colored data large-screen page includes related information of the to-be-colored component. The to-be-colored data large-screen page includes one or more component types of the to-be-colored component. The component information of the to-be-colored data large-screen page includes the component type of each to-be-colored component. Taking the to-be-colored data large-screen page shown in FIG. 3 as an example, the component information of the to-be-colored data large-screen page includes “XXX business monitoring” as a background-type component, the bar chart as a category-type component, the pie chart as a category-type component, the bubble chart as a numerical-type component, the decorative border as a decorative-type component, and the table as a background-type component.

The component information of the to-be-colored data large-screen page may be generated by the user in a process of editing the to-be-colored data large-screen page, or may be obtained by performing recognition and analysis on the to-be-colored data large-screen page. As an example, the component information of the to-be-colored data large-screen page is a POMtree. The POMtree includes the component type of each to-be-colored component of the to-be-colored data large-screen page.

In some possible implementations, the component type includes one or more of the group consisting of a category-type component, a numerical-type component, a decorative-type component, and a background-type component.

The category-type component includes text of a plurality of contents. The category-type component uses different colors to represent text of different content. The text is data or characters. The category-type component is, for example, a bar chart, a line chart, a scatter chart, a pie chart, a rose chart, a funnel chart, a sankey chart, a radar chart, or a table. For example, referring to FIG. 3, the bar chart is a category-type component. The bar chart is used to display “cost”, “sales volume”, and “net profit” for each month from January to March. The bar chart includes text of three contents, that is, “cost”, “sales volume”, and “net profit”.

The numerical-type component includes data of a plurality of numerical values. The numerical-type component uses color shades to represent numerical changes of the data. As some examples, the numerical-type component is, for example, a bubble chart, a circular view, or a heat map.

The decorative-type component is a component with a decorative effect. The decorative-type component is, for example, a component for decorating the data large-screen page, such as a title background, a decorative line, a border, a table line, and the like.

The background-type component is a component that constitutes the background of the to-be-colored data large-screen page. The background-type component is, for example, a component used as a background, such as title text, a flipper, an icon graphic, text, and the like.

In addition to obtaining the to-be-colored data large-screen page and the component information of the to-be-colored data large-screen page, the preset color palette is also obtained. The preset color palette is used to determine the target color of the to-be-colored component. The preset color palette includes one or more basic colors. The basic colors included in the preset color palette may be pre-selected by the user, or preset default colors.
S202: Determine a target color of a target component based on a component type of the target component.

The to-be-colored components of different component types have corresponding methods for determining the target color. The component type of the target component may be determined according to the component information of the to-be-colored data large-screen page. The target component is one of the to-be-colored components included in the to-be-colored data large-screen page. The target color of the target component is determined based on one or more colors selected from a group consisting of the preset color palette and the background color of the to-be-colored data large-screen page.

As some examples, the embodiment of the present disclosure provides specific implementations of the target color of the target component of four component types, which will be described below.
S203: Color the target component with the target color to obtain the colored data large-screen page.

The target component is colored with the determined target color. The embodiment of the present disclosure does not limit the manner of coloring the target component. In a possible implementation, after the target color of the target component is determined, the target component included in the to-be-colored data large-screen page is colored. In another possible implementation, after the target color of each target component included in the to-be-colored data large-screen page is determined, the coloring process is performed on each target component included in the to-be-colored data large-screen page together.

Based on the foregoing related content of S201-S203, it can be learnt that the target color of the to-be-colored component is determined according to the component type of the to-be-colored component, and coloring is performed with the target color. In this way, automatic coloring of the to-be-colored data large-screen page can be realized, and efficiency of generating the data large-screen page can be improved.

In some possible implementations, the component type includes one or more of the group consisting of a category-type component, a numerical-type component, a decorative-type component, and a background-type component. The embodiment of the present disclosure provides specific implementations of the target color of the target component of the above four component types, respectively.

For example, the target component is a category-type component.

The target color of the text with the same content information in the category-type component needs to be consistent. Taking the bar chart shown in FIG. 3 as an example, the bar chart includes three contents, that is, “cost”, “sales volume”, and “net profit”, and the bar area representing “cost”, the bar area representing “sales volume”, and the bar area representing “net profit” have different colors, and the bar areas representing the text of the same content information in the bar chart have the same color.

Determining the target color of the target component by using the color matching method corresponding to the component type of the target component includes the following two steps.
A1: Obtain a plurality of texts included in the target component from the component information of the to-be-colored data large-screen page.

The component information of the to-be-colored data large-screen page further includes a plurality of texts included in each category-type component. Each text included in the target component is obtained from the component information of the to-be-colored data large-screen page.
A2: Determine the target color corresponding to text of each content of the target component.

The target component may include a plurality of texts. The plurality of texts include text of different contents. The target color corresponding to the text of each content is determined.

The target color corresponding to the text of each content may be obtained based on the preset color palette. In a possible implementation, the target color may be the basic color of the preset color palette. The corresponding basic color is allocated to the text of different content as the target color based on the plurality of basic colors included in the preset color palette. In another possible implementation, the target color is an extended color. In a possible case, the extended color is obtained by mixing a plurality of basic colors included in the preset color palette. For example, the preset color palette includes red and yellow. Red and yellow are mixed to obtain the extended color orange. In another possible case, the extended color is obtained by adjusting the brightness of the basic color included in the preset color palette. For example, the preset color palette includes light red, and the extended color is dark red obtained by adjusting the brightness of the light red.

The embodiment of the present disclosure does not limit the manner of determining the target color corresponding to text of each content of the target component.

In a possible implementation, the corresponding target color is allocated to the text of each content based on the basic color included in the preset color palette or the extended color.

In another possible implementation, a coloring area of one of the plurality of texts included in the target component, that is the coloring area of the target text, is obtained, and an adjacent area of the coloring area is obtained and the target color of the target text is determined based on the color of the adjacent area. The coloring area of the target text is an area corresponding to the target text and that needs to be colored with the target color. Taking the above target component as the bar chart as an example, the bar area included in the bar chart of the to-be-colored data large-screen page is the area that needs to be colored. The adjacent area of the coloring area may be obtained by performing image processing on the to-be-colored data large-screen page. An image processing algorithm is used to divide the area that needs to be colored on the to-be-colored data large-screen page, to obtain the coloring area and the adjacent area adjacent to the coloring area.

A plurality of first candidate colors are determined based on the preset color palette. The first metric value of each first candidate color is calculated. The first candidate color with the highest first metric value is then used as the target color corresponding to the target text. The first metric value is calculated according to one or more of a group consisting of the harmony between the first candidate color and the coloring color of the adjacent area, the distinction between the first candidate color and the coloring color of the adjacent area, and the continuity between the first candidate color and the coloring color of the adjacent area. The harmony, the distinction, and the continuity may all be calculated using corresponding formulas. In some possible implementations, the weight corresponding to the adjacent area is configured based on the degree of adjacency between the coloring area and the adjacent area. The degree of adjacency between the coloring area and the adjacent area may be determined based on the boundary length between the coloring area and the adjacent area. The degree of adjacency is positively correlated with the boundary length. The weight corresponding to the adjacent area is used to adjust the values of the harmony, the distinction, and the continuity calculated using the color of the adjacent area. For example, the calculated harmony between the first candidate color and the color of the adjacent area is multiplied by the weight of the adjacent area to obtain the updated harmony.

In order to maintain the same target color for the text with the same content included in the to-be-colored data large-screen page, the correspondence between the target text and the target color is established. In this way, when determining the target color corresponding to the text subsequently, the correspondence between the target text and the target color established historically may be queried. If the correspondence between the target text and the target color that needs to be determined this time can be queried, the target color corresponding to the target text can be determined. If the correspondence between the target text and the target color that needs to be determined this time cannot be queried, the target color corresponding to the target text is determined from the first candidate colors. By using the established correspondence between the target text and the target color, the color of the text with the same content in the to-be-colored data large-screen page can be kept the same.

For example, the target component is a numerical-type component.

The numerical-type component includes data of a plurality of numerical values. The numerical-type component can use color shades to represent numerical changes of the data. For example, taking the numerical-type component as a heat map as an example, the target color of the numerical-type component is red. The corresponding target color for coloring the coloring area is dark red for higher data numerical values. The corresponding target color for coloring the coloring area is light red for lower data numerical values.

The embodiment of the present disclosure provides a specific implementation of determining the target color of the target component based on the component type of the target component, including the following.
B1: Calculate a brightness of each second candidate color and a difference degree between each second candidate color and the background color.

The second candidate color is a color determined according to the preset color palette. The second candidate color may be a basic color included in the preset color palette or an extended color. Each second candidate color has a different color system.

The brightness of the second candidate color is used to measure the depth of the second candidate color. The brightness of the second candidate color may be calculated using formula (1).

$${C}_{1} = - 2.1 + 0.05 \times ( 100 - L ) \qquad ( 1 )$$

L is the luminance of the second candidate color, and C1 is the brightness of the second candidate color. The deeper the second candidate color, the greater the value of C1; the lighter the second candidate color, the smaller the value of C1.

The difference degree between the second candidate color and the background color is used to measure the difference between the second candidate color and the background color. The difference degree between the second candidate color and the background color is calculated using formula (2).

$${C}_{2} = \sqrt{{( {L}_{i} - {L}_{j} )}^{2} + {( {a}_{i} - {a}_{j} )}^{2} + {( {b}_{i} - {b}_{j} )}^{2}} \qquad ( 2 )$$

Lᵢ, aᵢ, and bᵢ represent three components of the second candidate color in the LAB (Lab color space, color-opponent space), respectively. Lᵢ is the luminance of the second candidate color, and aᵢ and bᵢ represent color opponent dimensions. Lⱼ, aⱼ, and bⱼ represent three components of the background color in the LAB, respectively. Lⱼ is the luminance of the background color, and aⱼ and bⱼ represent color opponent dimensions.
B2: Calculate a second metric value of each second candidate color by using the brightness and the difference degree.

The second metric value of the second candidate color may be a sum of the brightness of the second candidate color and the difference degree of the second candidate color, or a weighted sum. The weights corresponding to the brightness and the difference degree may be preset.
B3: Determine an extreme color according to the second metric value of each second candidate color, where the extreme color corresponds to an extreme value data included in the numerical-type component.

The target color corresponding to the extreme numerical value, that is, the extreme color, is first determined according to the calculated second metric value of each second candidate color. The extreme numerical value is the data with the largest numerical value and the data with the smallest numerical value included in the numerical-type component. The component information of the to-be-colored data large-screen page further includes the numerical value of the data of each numerical-type component. The extreme value data is obtained from the component information of the to-be-colored data large-screen page. The target color corresponding to the extreme numerical value may be the second candidate color with the largest or smallest second metric value. For example, the target color corresponding to the data with the largest numerical value is the second candidate color with the largest second metric value. The target color corresponding to the data with the smallest numerical value is the second candidate color with the smallest second metric value. Alternatively, for example, the target color corresponding to the data with the largest numerical value is the second candidate color with the largest second metric value. The target color corresponding to the data with the smallest numerical value is the second candidate color with the second largest second metric value in descending order.

In a possible implementation, the extreme value data includes median data. The median data is a preset numerical value. For example, the median data is 0. If the extreme value data includes the median data, for example, the data with the largest numerical value is the median data, or the data with the smallest numerical value is the median data, the neutral color is used as the color corresponding to the median data. The extreme color is determined for another piece of extreme value data based on the second metric value of each second candidate color.

In another possible implementation, the extreme value data does not include the median data. The number of extreme colors is two. To prevent a large hue difference between the two extreme colors, the hue difference between the two extreme colors is calculated. If the hue difference between the two extreme colors is not within the preset range, the extreme color needs to be re-determined according to the second metric value of each second candidate color. If the hue difference between the two extreme colors is within the preset range, the two extreme colors are determined. The preset range is greater than or equal to 120 and less than or equal to 240.
B4: Determine a third candidate color of the data other than the extreme value data included in the numerical-type component according to the extreme color.

After the extreme color is obtained, the third candidate color corresponding to the data other than the extreme value data is determined by using the extreme color. The brightness of the third candidate color is less than the brightness of the extreme color, and the third candidate color and the extreme color belong to the same color system. The third candidate color may be determined by using a color brightness mapping algorithm. The extreme color and the third candidate color may form a step color palette for coloring the numerical-type component.

In a possible implementation, the brightness of the third candidate color corresponding to the numerical value of the data other than the extreme value data is determined by using the correspondence between the extreme numerical value and the brightness of the extreme color.

For example, the extreme value data includes the median data 0. The neutral color corresponding to the median data is white. The extreme color determined in step B3 is dark red, the brightness of the dark red is A, and the extreme numerical value is 100. The brightness of the third candidate color corresponding to the data with the numerical value 50 is one-half of A in red. For another example, the extreme value data does not include the median data. The extreme colors determined in step B3 are dark red and dark blue. The extreme numerical values are 100 and −100. The extreme color corresponding to the extreme numerical value 100 is dark red, and the brightness of the dark red is A. The extreme color corresponding to the extreme numerical value −100 is dark blue, and the brightness of the dark blue is B. The third candidate color corresponding to the data with the numerical value 100 to 0 is red. The third candidate color corresponding to the data with the numerical value 0 to −100 is blue. The brightness of the third candidate color corresponding to the data with the numerical value 50 is one-half of A in red. The brightness of the third candidate color corresponding to the data with the numerical value −25 is one-fourth of A in blue.

For example, the target component is a decorative-type component.

The decorative-type component may be selected by the user from a component library. The decorative-type component has an initial color.

The embodiment of the present disclosure provides a specific implementation of determining the target color of the target component based on the component type of the target component, including the following.
C1: Obtain the initial color of the decorative-type component from the component information of the to-be-colored data large-screen page.

The initial color of the decorative-type component may be inconsistent with the overall color matching of the to-be-colored data large-screen page, and the color of the decorative-type component needs to be changed. The component information of the to-be-colored data large-screen page further includes the initial color of each decorative-type component. The initial color of each decorative-type component is obtained from the component information of the to-be-colored data large-screen page. The number of initial colors of the decorative-type component may be one color or a plurality of colors.
C2: Determine the target color according to the initial color and the basic color included in the preset color palette.

The initial color of the decorative-type component is set according to an initial color scheme of the decorative-type component. The target color is determined by using the basic color included in the preset color palette, on the basis of maintaining the initial color scheme of the decorative-type component by using the initial color of the decorative-type component.

In a possible implementation, there is only one initial color. The basic color with the smallest difference degree from the initial color is selected from the basic colors included in the preset color palette as the target color.

In another possible implementation, there are a plurality of initial colors. The initial color includes an initial main color and an initial secondary color. The initial main color is an initial color that is mainly used to color the decorative-type component. The initial secondary color is an initial color that is used to assist in coloring the decorative-type component. The color difference between the initial main color and the initial secondary color is calculated. The color difference may be obtained by calculating the difference between the color matrix of the initial main color and the color matrix of the initial secondary color. The target main color is then determined based on the preset color palette. The target main color may be the basic color included in the preset color palette or the extended color. Finally, the target secondary color is calculated by using the target main color and the color difference between the initial main color and the initial secondary color.

For example, the target component is a background-type component.

The background-type component is a component that constitutes the background of the to-be-colored data large-screen page. The background-type component generally adopts a neutral color.

The embodiment of the present disclosure provides a specific implementation of determining the target color of the target component based on the component type of the target component, including the following.
D1: Calculate a distinction between each fourth candidate color and the background color, where the fourth candidate color is a neutral color.

The background-type component needs to have a high distinction from the background color of the to-be-colored data large-screen page, so that it can be easily recognized during viewing. The distinction between the fourth candidate color and the background color is calculated. The distinction is calculated using formulas (3)-(27).

$$Δ E = \sqrt{{( \frac{Δ {L}^{′}}{{K}_{L} {S}_{L}} )}^{2} + {( \frac{Δ {C}^{′}}{{K}_{C} {S}_{C}} )}^{2} + {( \frac{Δ {H}^{′}}{{K}_{H} {S}_{H}} )}^{2} + {R}_{T} ( \frac{Δ {C}^{′}}{{K}_{C} {S}_{C}} ) ( \frac{Δ {H}^{′}}{{K}_{H} {S}_{H}} )} \qquad ( 3 )$$

$${\overline{L}}^{′} = ( {L}_{1} + {L}_{2} ) / 2 \qquad ( 4 )$$

$${C}_{1} = \sqrt{{a}_{1}^{2} + {b}_{1}^{2}} \qquad ( 5 )$$

$${C}_{2} = \sqrt{{a}_{2}^{2} + {b}_{2}^{2}} \qquad ( 6 )$$

$$\overline{C} = ( {C}_{1} + {C}_{2} ) / 2 \qquad ( 7 )$$

$$G = \frac{1}{2} ( 1 - \sqrt{\frac{{\overline{C}}^{7}}{{\overline{C}}^{7} + 2 {5}^{7}}} ) \qquad ( 8 )$$

$${a}_{1}^{′} = {a}_{1} ( 1 + G ) \qquad ( 9 )$$

$${a}_{2}^{′} = {a}_{2} ( 1 + G ) \qquad ( 10 )$$

$${C}_{1}^{′} = \sqrt{{a}_{1}^{′ 2} + {b}_{1}^{2}} \qquad ( 11 )$$

$${C}_{2}^{′} = \sqrt{{a}_{2}^{′ 2} + {b}_{2}^{2}} \qquad ( 12 )$$

$${\overline{C}}^{′} = ( {C}_{1}^{′} + {C}_{2}^{′} ) / 2 \qquad ( 13 )$$

$${h}_{1}^{′} = \{ \begin{matrix}arctan ( {b}_{1} / {a}_{1}^{′} ) & arctan ( {b}_{1} / {a}_{1}^{′} ) \geq 0 \\ arctan ( {b}_{1} / {a}_{1}^{′} ) + 306 ° & other\end{matrix} \qquad ( 14 )$$

$${h}_{2}^{′} = \{ \begin{matrix}arctan ( {b}_{2} / {a}_{2}^{′} ) & arctan ( {b}_{2} / {a}_{2}^{′} ) \geq 0 \\ arctan ( {b}_{2} / {a}_{2}^{′} ) + 306 ° & other\end{matrix} \qquad ( 15 )$$

$${\overline{H}}^{′} = \{ \begin{matrix}{h}_{1}^{′} + {h}_{2}^{′} + 360 ° / 2 & \vert {h}_{1}^{′} - {h}_{2}^{′} \vert > 180 ° \\ ( {h}_{1}^{′} + {h}_{2}^{′} ) / 2 & other\end{matrix} \qquad ( 16 )$$

$$T = 1 - 0.17 cos ( {\overline{H}}^{′} - 30 ° ) + 0.24 cos ( 2 {\overline{H}}^{′} ) + 0.32 cos ( 3 {\overline{H}}^{′} + 6 ° ) - 0.2 cos ( 4 {\overline{H}}^{′} - 63 ° ) \qquad ( 17 )$$

$$Δ {h}^{′} = \{ \begin{matrix}{h}_{2}^{′} + {h}_{1}^{′} & \vert {h}_{1}^{′} - {h}_{1}^{′} \vert \leq 180 ° \\ {h}_{2}^{′} + {h}_{1}^{′} + 360 ° & \vert {h}_{2}^{′} - {h}_{2}^{′} \vert > 180 \text{?} {h}_{2}^{′} \leq \\ {h}_{2}^{′} + {h}_{1}^{′} + 360 ° & other\end{matrix} {h}_{1}^{′}$$

$$Δ {L}^{′} = {L}_{1} + {L}_{2} \qquad ( 19 )$$

$$Δ {C}^{′} = {C}_{2}^{′} - {C}_{1}^{′} \qquad ( 20 )$$

$$Δ {H}^{′} = 2 \sqrt{{C}_{2}^{′} {C}_{1}^{′}} sin ( Δ {h}^{′} / 2 ) \qquad ( 21 )$$

$${S}_{L} = 1 + 0.015 {( {\overline{L}}^{′} - 50 )}^{2} / \sqrt{20 + {( {\overline{L}}^{′} - 50 )}^{2}} \qquad ( 22 )$$

$${S}_{C} = 1 + 0.045 {\overline{C}}^{′} \qquad ( 23 )$$

$${S}_{H} = 1 + 0 \text{.01} 5 {\overline{C}}^{′} T \qquad ( 24 )$$

$$Δ θ = 30 exp \{ - {( \frac{{\overline{H}}^{′} - 275 °}{25} )}^{2} \} \qquad ( 25 )$$

$${R}_{C} = 2 \sqrt{\frac{{\overline{C}}^{7}}{{\overline{C}}^{7} + 2 {5}^{7}}} \qquad ( 26 )$$

$${R}_{T} = - {R}_{C} sin ( 2 Δ θ ) \qquad ( 27 )$$

ΔE is the distinction between the fourth candidate color and the background color. L₁, a₁, and b₁ represent three components of the fourth candidate color in the LAB, respectively. L₁ is the luminance of the background color, and a₁ and b₁ represent color opponent dimensions of the fourth candidate color. L₂, a₂, and b₂ represent three components of the background color in the LAB, respectively. L₂ is the luminance of the background color, and a₂ and b₂ represent color opponent dimensions of the background color. K_{L}, K_{C}, and K_{H} are default values.
D2: Select a fourth candidate color with the distinction greater than a distinction threshold as the target color of the target component.

The distinction threshold is predetermined. The fourth candidate color with the distinction greater than the distinction threshold has a significant distinction from the background color. The fourth candidate color with the distinction greater than the distinction threshold is used as the target color of the target component.

Based on the above content, components of different component types have corresponding methods for determining the target color. In this way, the target color that meets the display requirement of the component type can be determined, and a more suitable target color can be determined.

Based on the data large-screen page processing method provided by the above method embodiment, the embodiment of the present disclosure further provides a data large-screen page processing apparatus, which will be described below with reference to the drawings.

Referring to FIG. 4, which is a schematic diagram of a structure of a data large-screen page processing apparatus provided by an embodiment of the present disclosure. As shown in FIG. 4, the data large-screen page processing apparatus includes:
an obtaining unit 401, configured to obtain a to-be-colored data large-screen page, component information of the to-be-colored data large-screen page, and a preset color palette, where the to-be-colored data large-screen page includes to-be-colored components, the component information includes a component type of each to-be-colored component, and the preset color palette includes one or more basic colors;
a determining unit 402, configured to determine a target color of a target component based on a component type of the target component, where the target component is one of the to-be-colored components included in the to-be-colored data large-screen page, and the target color is determined based on one or more colors selected from a group consisting of the preset color palette and a background color of the to-be-colored data large-screen page; and
a coloring unit 403, configured to color the target component with the target color to obtain a colored data large-screen page.

In a possible implementation, the component type of the target component is a category-type component, the category-type component includes text of a plurality of contents, the category-type component is a component that uses different colors to represent the text of different content, and the component information of the to-be-colored data large-screen page further includes a plurality of texts included in each category-type component, and the determining unit 402 is configured to determine the target color of the target component based on the component type of the target component, including:
the determining unit 402 is configured to obtain a plurality of texts included in the target component from the component information of the to-be-colored data large-screen page, and determine the target color corresponding to text of each content of the target component, where the target color is obtained based on the preset color palette.

In a possible implementation, the determining unit 402 is configured to determine the target color corresponding to text of each content of the target component, including:
the determining unit 402 is configured to determine, from the to-be-colored data large-screen page, a coloring area of a target text and an adjacent area of the coloring area, where the target text is one of the plurality of texts included in the target component; calculate a first metric value of each first candidate color, where the first candidate color is determined according to the preset color palette, and the first metric value of the first candidate color is calculated according to one or more of a group consisting of a harmony between the first candidate color and a color of the adjacent area, a distinction between the first candidate color and the color of the adjacent area, and a continuity between the first candidate color and the color of the adjacent area; and use a first candidate color with a highest first metric value as the target color corresponding to the target text.

In a possible implementation, the apparatus further includes:
an establishing unit, configured to establish a correspondence between the target text and the target color.

In a possible implementation, the determining unit 402 is configured to determine the target color corresponding to text of each content of the target component, including:
the determining unit 402 is configured to query to obtain a target color corresponding to each text included in the target component.

In a possible implementation, the target color is a basic color of the preset color palette, or an extended color, where the extended color is obtained by mixing a plurality of basic colors included in the preset color palette, or is obtained by adjusting a brightness of a basic color included in the preset color palette.

In a possible implementation, the component type of the target component is a numerical-type component, the numerical-type component includes data of a plurality of numerical values, the numerical-type component is a component that uses color shades to represent numerical changes of the data, the numerical-type component includes data of a plurality of numerical values, the component information of the to-be-colored data large-screen page further includes the numerical value of the data of each numerical-type component, and the determining unit 402 is configured to determine the target color of the target component based on the component type of the target component, including:
the determining unit 402 is configured to calculate a brightness of each second candidate color and a difference degree between each second candidate color and the background color, where the second candidate color is a color determined according to the preset color palette; calculate a second metric value of each second candidate color by using the brightness and the difference degree; determine an extreme color according to the second metric value of each second candidate color, where the extreme color corresponds to an extreme value data included in the numerical-type component, and the extreme value data is obtained from the component information of the to-be-colored data large-screen page; and determine a third candidate color of data other than the extreme value data included in the numerical-type component according to the extreme color, where a brightness of the third candidate color is less than a brightness of the extreme color, and the third candidate color and the extreme color belong to a same color system.

In a possible implementation, the extreme value data included in the numerical-type component includes median data, and the determining unit 402 is further configured to use a neutral color as a color corresponding to the median data.

In a possible implementation, the extreme value data included in the numerical-type component does not include median data, two extreme colors are determined, and the hue difference between the two extreme colors is within a preset range.

In a possible implementation, the component type of the target component is a decorative-type component, the decorative-type component is a component with a decorative effect, and the component information of the to-be-colored data large-screen page further includes an initial color of each decorative-type component, and the determining unit 402 is configured to determine the target color of the target component based on the component type of the target component, including:
the determining unit 402 is configured to obtain the initial color of the decorative-type component from the component information of the to-be-colored data large-screen page, and determine the target color according to the initial color and the basic color included in the preset color palette.

In a possible implementation, the initial color includes an initial main color and an initial secondary color, and the determining unit 402 is configured to determine the target color according to the initial color and the basic color included in the preset color palette, including:
the determining unit 402 is configured to calculate a color difference between the initial main color and the initial secondary color, and calculate a target secondary color by using a target main color and the color difference, where the target main color is determined based on the preset color palette, the target main color is the target color corresponding to the target component with the color of the initial main color, and the target secondary color is the target color corresponding to the target component with the color of the initial secondary color.

In a possible implementation, the component type of the target component is a background-type component, the background-type component is a component that constitutes the background of the to-be-colored data large-screen page, and the determining unit 402 is configured to determine the target color of the target component based on the component type of the target component, including:
the determining unit 402 is configured to calculate a distinction between each fourth candidate color and the background color, where the fourth candidate color is a neutral color, and select a fourth candidate color with the distinction greater than a distinction threshold as the target color of the target component.

Based on the data large-screen page processing method provided by the above method embodiment, the present disclosure further provides an electronic device, including: one or more processors; and a storage apparatus, configured to store one or more programs, where the one or more programs, when executed by the one or more processors, cause the one or more processors to implement the data large-screen page processing method according to any one of the above embodiments.

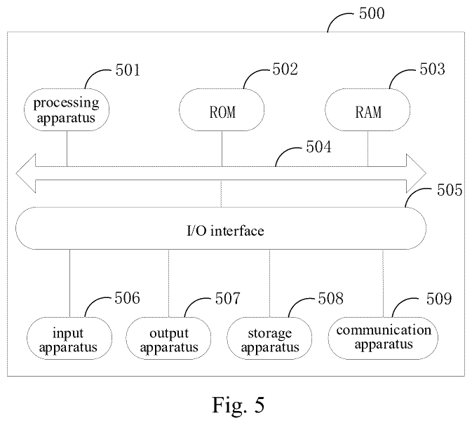

Reference is made to FIG. 5 below, which illustrates a schematic diagram of a structure of an electronic device 500 suitable for implementing the embodiments of the present disclosure. The terminal device in the embodiment of the present disclosure may include, but is not limited to, a mobile terminal such as a mobile phone, a laptop, a digital broadcast receiver, a personal digital assistant (PDA), a portable android device (PAD), a portable media player (PMP), a vehicle-mounted terminal (such as a vehicle navigation terminal), and a fixed terminal such as a digital television (TV) and a desktop computer. The electronic device shown in FIG. 5 is only an example, and should not impose any limitation to the function and scope of use of the embodiments of the present disclosure.

As shown in FIG. 5, the electronic device 500 may include a processing apparatus 501 (such as a central processing unit and a graphics processing unit), which can perform various appropriate actions and processing according to a program stored in a read-only memory (ROM) 502 or a program loaded from a storage apparatus 508 into a random access memory (RAM) 503. The RAM 503 further stores various programs and data required for the operation of the electronic device 500. The processing apparatus 501, the ROM 502, and the RAM 503 are connected to each other through a bus 504. An input/output (I/O) interface 505 is also connected to the bus 504.

Generally, the following apparatus may be connected to the I/O interface 505: an input apparatus 508 including, for example, a touch screen, a touch pad, a keyboard, a mouse, a camera, a microphone, an accelerometer, a gyroscope, and the like; an output apparatus 507 including, for example, a liquid crystal display (LCD), a speaker, a vibrator, and the like; a storage apparatus 508 including, for example, a magnetic tape, a hard disk, and the like; and a communication apparatus 509. The communication apparatus 509 may allow the electronic device 500 to perform wireless or wired communication with other devices to exchange data. Although FIG. 5 shows the electronic device 500 having various apparatus, it should be understood that not all of the illustrated apparatus are necessarily implemented or included. More or fewer apparatus may alternatively be implemented or included.

In particular, according to an embodiment of the present disclosure, the process described above with reference to the flowchart may be implemented as a computer software program. For example, an embodiment of the present disclosure provides a computer program product, which includes a computer program carried on a non-transitory computer-readable medium, and the computer program includes program code for executing the method shown in the flowchart. In such an embodiment, the computer program may be downloaded and installed from the network through the communication apparatus 509, or may be installed from the storage apparatus 508, or may be installed from the ROM 502. When the computer program is executed by the processing apparatus 501, the above functions defined in the method of the embodiment of the present disclosure are executed.

The electronic device provided by the embodiment of the present disclosure belongs to the same inventive concept as the data large-screen page processing method provided by the above embodiment, and for the technical details not described in detail in this embodiment, reference may be made to the above embodiment, and this embodiment has the same beneficial effects as the above embodiment.

Based on the data large-screen page processing method provided by the above method embodiment, the embodiment of the present disclosure provides a computer storage medium, which is configured to store a computer program, where the computer program, when executed by a processor, implements the data large-screen page processing method according to any one of the above embodiments.

It should be noted that the above computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program, and the program may be used by or in combination with an instruction execution system, apparatus, or device. In the present disclosure, the computer-readable signal medium may include a data signal propagated in a baseband or as a part of a carrier, and computer-readable program code is carried in the data signal. The data signal propagated in this manner may be in various forms, including but not limited to an electromagnetic signal, an optical signal, or any suitable combination thereof. The computer-readable signal medium may also be any computer-readable medium other than the computer-readable storage medium, and the computer-readable signal medium may send, propagate, or transmit a program used by or in combination with an instruction execution system, apparatus, or device. The program code contained on the computer-readable medium may be transmitted by using any suitable medium, including but not limited to an electrical wire, an optical cable, radio frequency (RF), or any suitable combination thereof.

In some implementations, clients and servers may communicate using any currently known or future-developed network protocol, such as the Hypertext transfer protocol (HTTP), and may be interconnected with any form or medium of digital data communication (for example, a communication network). Examples of the communication network include a local area network (“LAN”), a wide area network (“WAN”), an internetwork (for example, the Internet), and a peer-to-peer network (for example, an ad hoc network), as well as any currently known or future-developed network.

The computer-readable medium may be included in the electronic device, or may exist alone without being assembled into the electronic device.

The computer-readable medium carries one or more programs, and the one or more programs, when executed by the electronic device, cause the electronic device to perform the data large-screen page processing method.

The computer program codes for executing the operations of the present disclosure may be written in one or more programming languages or a combination thereof. The above-mentioned programming languages include but are not limited to object-oriented programming languages such as Java, Smalltalk, C++, and also include conventional procedural programming languages such as Cor similar programming languages. The program code may be executed entirely on a user's computer, partly on a user's computer, as a stand-alone software package, partly on a user's computer and partly on a remote computer, or entirely on a remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, and the module, the program segment, or the portion of codes contains one or more executable instructions for implementing specified logical functions. It should also be noted that, in some alternative implementations, the functions noted in the blocks may also occur in an order different from that noted in the drawings. For example, two blocks shown in succession may, in fact, be executed substantially concurrently, or the blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units described in the embodiments of the present disclosure may be implemented by means of software, or may also be implemented by means of hardware. Among them, the name of the unit/module does not constitute a limitation on the unit itself under certain circumstances, for example, the voice data acquisition module may also be described as a “data acquisition module”.

The functions described herein above may be performed, at least partially, by one or more hardware logic components. For example, without limitation, illustrative types of hardware logic components that can be used include: a field-programmable gate array (FPGA), an application-specific integrated circuit (ASIC), an application-specific standard product (ASSP), a system on chip (SOC), a complex programmable logical device (CPLD), etc.

In the context of the present disclosure, a machine-readable medium may be a tangible medium that may include or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage medium may include an electrical connection with one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

According to one or more embodiments of the present disclosure, Example 1 provides a data large-screen page processing method, including:
obtaining a to-be-colored data large-screen page, component information of the to-be-colored data large-screen page, and a preset color palette, where the to-be-colored data large-screen page includes to-be-colored components, the component information includes a component type of each to-be-colored component, and the preset color palette includes one or more basic colors;
determining a target color of a target component based on a component type of the target component, where the target component is one of the to-be-colored components included in the to-be-colored data large-screen page, and the target color is determined based on one or more colors selected from a group consisting of the preset color palette and a background color of the to-be-colored data large-screen page; and
coloring the target component with the target color to obtain a colored data large-screen page.

According to one or more embodiments of the present disclosure, Example 2 provides a data large-screen page processing method, where the component type of the target component is a category-type component, the category-type component includes text of a plurality of contents, the category-type component is a component that uses different colors to represent text of different content, the component information of the to-be-colored data large-screen page further includes a plurality of texts included in each category-type component, and the determining the target color of the target component based on the component type of the target component includes:
obtaining a plurality of texts included in the target component from the component information of the to-be-colored data large-screen page; and
determining the target color corresponding to text of each content of the target component, where the target color is obtained based on the preset color palette.

According to one or more embodiments of the present disclosure, Example 3 provides a data large-screen page processing method, where the determining the target color corresponding to text of each content of the target component includes:
determining, from the to-be-colored data large-screen page, a coloring area of a target text and an adjacent area of the coloring area, where the target text is one of the plurality of texts included in the target component;
calculating a first metric value of each first candidate color, where the first candidate color is determined according to the preset color palette, and the first metric value of the first candidate color is calculated according to one or more of a group consisting of a harmony between the first candidate color and a color of the adjacent area, a distinction between the first candidate color and the color of the adjacent area, and a continuity between the first candidate color and the color of the adjacent area; and
using a first candidate color with a highest first metric value as the target color corresponding to the target text.

According to one or more embodiments of the present disclosure, Example 4 provides a data large-screen page processing method, where the method further includes:
establishing a correspondence between the target text and the target color.

According to one or more embodiments of the present disclosure, Example 5 provides a data large-screen page processing method, where the determining the target color corresponding to text of each content of the target component includes:
querying to obtain a target color corresponding to each text included in the target component.

According to one or more embodiments of the present disclosure, Example 6 provides a data large-screen page processing method, where the target color is a basic color of the preset color palette, or an extended color, where the extended color is obtained by mixing a plurality of basic colors included in the preset color palette, or is obtained by adjusting a brightness of a basic color included in the preset color palette.

According to one or more embodiments of the present disclosure, Example 7 provides a data large-screen page processing method, where the component type of the target component is a numerical-type component, the numerical-type component includes data of a plurality of numerical values, the numerical-type component is a component that uses color shades to represent numerical changes of the data, the numerical-type component includes data of a plurality of numerical values, and the component information of the to-be-colored data large-screen page further includes the numerical value of the data of each numerical-type component, and the determining the target color of the target component based on the component type of the target component includes:
calculating a brightness of each second candidate color and a difference degree between each second candidate color and the background color, where the second candidate color is a color determined according to the preset color palette;
calculating a second metric value of each second candidate color by using the brightness and the difference degree;
determining an extreme color according to the second metric value of each second candidate color, where the extreme color corresponds to an extreme value data included in the numerical-type component, and the extreme value data is obtained from the component information of the to-be-colored data large-screen page; and
determining a third candidate color of data other than the extreme value data included in the numerical-type component according to the extreme color, where a brightness of the third candidate color is less than a brightness of the extreme color, and the third candidate color and the extreme color belong to a same color system.

According to one or more embodiments of the present disclosure, Example 8 provides a data large-screen page processing method, where the extreme value data included in the numerical-type component includes median data, and the method further includes:
using a neutral color as a color corresponding to the median data.

According to one or more embodiments of the present disclosure, Example 9 provides a data large-screen page processing method, where the extreme value data included in the numerical-type component does not include median data, two extreme colors are determined, and a hue difference between the two extreme colors is within a preset range.

According to one or more embodiments of the present disclosure, Example 10 provides a data large-screen page processing method, where the component type of the target component is a decorative-type component, the decorative-type component is a component with a decorative effect, the component information of the to-be-colored data large-screen page further includes an initial color of each decorative-type component, and the determining the target color of the target component based on the component type of the target component includes:
obtaining the initial color of the decorative-type component from the component information of the to-be-colored data large-screen page; and
determining the target color according to the initial color and the basic color included in the preset color palette.

According to one or more embodiments of the present disclosure, Example 11 provides a data large-screen page processing method, where the initial color includes an initial main color and an initial secondary color, and the determining the target color according to the initial color and the basic color included in the preset color palette includes:
calculating a color difference between the initial main color and the initial secondary color; and
calculating a target secondary color by using a target main color and the color difference, where the target main color is determined based on the preset color palette, the target main color is the target color corresponding to the target component with the color of the initial main color, and the target secondary color is the target color corresponding to the target component with the color of the initial secondary color.

According to one or more embodiments of the present disclosure, Example 12 provides a data large-screen page processing method, where the component type of the target component is a background-type component, the background-type component is a component that constitutes the background of the to-be-colored data large-screen page, and the determining the target color of the target component based on the component type of the target component includes:
calculating a distinction between each fourth candidate color and the background color, where the fourth candidate color is a neutral color; and
selecting a fourth candidate color with the distinction greater than a distinction threshold as the target color of the target component.

According to one or more embodiments of the present disclosure, Example 13 provides a data large-screen page processing apparatus, including:
an obtaining unit, configured to obtain a to-be-colored data large-screen page, component information of the to-be-colored data large-screen page, and a preset color palette, where the to-be-colored data large-screen page includes to-be-colored components, the component information includes a component type of each to-be-colored component, and the preset color palette includes one or more basic colors;
a first determining unit, configured to determine a target color of a target component based on a component type of the target component, where the target component is one of the to-be-colored components included in the to-be-colored data large-screen page, and the target color is determined based on one or more colors selected from a group consisting of the preset color palette and a background color of the to-be-colored data large-screen page; and
a coloring unit, configured to color the target component with the target color to obtain a colored data large-screen page.

According to one or more embodiments of the present disclosure, Example 14 provides a data large-screen page processing apparatus, where the component type of the target component is a category-type component, the category-type component includes text of a plurality of contents, the category-type component is a component that uses different colors to represent text of different content, the component information of the to-be-colored data large-screen page further includes a plurality of texts included in each category-type component, and the determining unit is configured to determine the target color of the target component based on the component type of the target component, including:
the determining unit is configured to obtain a plurality of texts included in the target component from the component information of the to-be-colored data large-screen page, and determine the target color corresponding to text of each content of the target component, where the target color is obtained based on the preset color palette.

According to one or more embodiments of the present disclosure, Example 15 provides a data large-screen page processing apparatus, where the determining unit is configured to determine the target color corresponding to text of each content of the target component, including:
the determining unit is configured to determine, from the to-be-colored data large-screen page, a coloring area of a target text and an adjacent area of the coloring area, where the target text is one of the plurality of texts included in the target component; calculate a first metric value of each first candidate color, where the first candidate color is determined according to the preset color palette, and the first metric value of the first candidate color is calculated according to one or more of a group consisting of a harmony between the first candidate color and a color of the adjacent area, a distinction between the first candidate color and the color of the adjacent area, and a continuity between the first candidate color and the color of the adjacent area; and use a first candidate color with a highest first metric value as the target color corresponding to the target text.

According to one or more embodiments of the present disclosure, Example 16 provides a data large-screen page processing apparatus, where the apparatus further includes:
an establishing unit, configured to establish a correspondence between the target text and the target color.

According to one or more embodiments of the present disclosure, Example 17 provides a data large-screen page processing apparatus, where the determining unit is configured to determine the target color corresponding to text of each content of the target component, including:
the determining unit is configured to query to obtain a target color corresponding to each text included in the target component.

According to one or more embodiments of the present disclosure, Example 18 provides a data large-screen page processing apparatus, where the target color is a basic color of the preset color palette, or an extended color, where the extended color is obtained by mixing a plurality of basic colors included in the preset color palette, or is obtained by adjusting a brightness of a basic color included in the preset color palette.

According to one or more embodiments of the present disclosure, Example 19 provides a data large-screen page processing apparatus, where the component type of the target component is a numerical-type component, the numerical-type component includes data of a plurality of numerical values, the numerical-type component is a component that uses color shades to represent numerical changes of the data, the numerical-type component includes data of a plurality of numerical values, and the component information of the to-be-colored data large-screen page further includes the numerical value of the data of each numerical-type component, and the determining unit is configured to determine the target color of the target component based on the component type of the target component, including:
the determining unit is configured to calculate a brightness of each second candidate color and a difference degree between each second candidate color and the background color, where the second candidate color is a color determined according to the preset color palette; calculate a second metric value of each second candidate color by using the brightness and the difference degree; determine an extreme color according to the second metric value of each second candidate color, where the extreme color corresponds to an extreme value data included in the numerical-type component, and the extreme value data is obtained from the component information of the to-be-colored data large-screen page; and determine a third candidate color of data other than the extreme value data included in the numerical-type component according to the extreme color, where a brightness of the third candidate color is less than a brightness of the extreme color, and the third candidate color and the extreme color belong to a same color system.

According to one or more embodiments of the present disclosure, Example 20 provides a data large-screen page processing apparatus, where the extreme value data included in the numerical-type component includes median data, and the apparatus further includes:
a second determining unit, configured to use the neutral color as the color corresponding to the median data.

According to one or more embodiments of the present disclosure, Example 21 provides a data large-screen page processing apparatus, where the extreme value data included in the numerical-type component does not include median data, two extreme colors are determined, and the hue difference between the two extreme colors is within the preset range.

According to one or more embodiments of the present disclosure, Example 22 provides a data large-screen page processing apparatus, where the component type of the target component is a decorative-type component, the decorative-type component is a component with a decorative effect, the component information of the to-be-colored data large-screen page further includes the initial color of each decorative-type component, and the determining unit is configured to determine the target color of the target component based on the component type of the target component, including:
the determining unit is configured to obtain the initial color of the decorative-type component from the component information of the to-be-colored data large-screen page, and determine the target color according to the initial color and the basic color included in the preset color palette.

According to one or more embodiments of the present disclosure, Example 23 provides a data large-screen page processing apparatus, where the initial color includes an initial main color and an initial secondary color, and the determining unit is configured to determine the target color according to the initial color and the basic color included in the preset color palette, including:
the determining unit is configured to calculate the color difference between the initial main color and the initial secondary color, and calculate the target secondary color by using the target main color and the color difference, where the target main color is determined based on the preset color palette, the target main color is the target color corresponding to the target component with the color of the initial main color, and the target secondary color is the target color corresponding to the target component with the color of the initial secondary color.

According to one or more embodiments of the present disclosure, Example 24 provides a data large-screen page processing apparatus, where the component type of the target component is a background-type component, the background-type component is a component that constitutes the background of the to-be-colored data large-screen page, and the determining unit is configured to determine the target color of the target component based on the component type of the target component, including:
the determining unit is configured to calculate the distinction between each fourth candidate color and the background color, where the fourth candidate color is a neutral color, and select a fourth candidate color with the distinction greater than the distinction threshold as the target color of the target component.

According to one or more embodiments of the present disclosure, Example 25 provides an electronic device, including:
one or more processors; and
a storage apparatus, configured to store one or more programs, where
the one or more programs, when executed by the one or more processors, cause the one or more processors to implement the method according to any one of Example 1 to Example 12.

According to one or more embodiments of the present disclosure, Example 26 provides a computer-readable medium, configured to store a computer program, where the computer program, when executed by a processor, causes the processor to implement the method according to any one of Example 1 to Example 12.

It should be noted that various embodiments in the present disclosure are described in a progressive manner, and each embodiment focuses on differences from other embodiments, and the same or similar parts between the various embodiments may refer to each other. For the system or apparatus disclosed in the embodiments, since it corresponds to the method disclosed in the embodiments, the description thereof is relatively simple, and reference may be made to the description of the method for relevant parts.

It should be understood that in the present disclosure, “at least one” refers to one or more, and “a plurality of” refers to two or more. “And/or” is used to describe an association relationship of associated objects, indicating that three relationships may exist. For example, “A and/or B” may represent: only A exists, only B exists, and both A and B exist at the same time, where A and B may be singular or plural. The character “/” generally indicates that the associated objects before and after are in an “or” relationship. “At least one of the following” or similar expressions refer to any combination of these items, including any combination of a single item (one) or a plurality of items (ones). For example, at least one (one) of a, b, or c may represent: a, b, c, “a and b”, “a and c”, “b and c”, or “a and b and c”, where a, b, and c may be singular or plural.

It should also be noted that in the present disclosure, relational terms such as “first” and “second” are only used to distinguish one entity or operation from another entity or operation, and do not necessarily require or imply any such actual relationship or order between these entities or operations. Moreover, the term “include/comprise” or any other variation thereof is intended to cover a non-exclusive inclusion, such that a process, method, article, or device that includes a list of elements not only includes those elements but also includes other elements not expressly listed or inherent to such process, method, article, or device. Without further limitation, an element defined by the phrase “include/comprise one . . . ” does not exclude the presence of additional same elements in the process, method, article, or device that includes the element.

The steps of the methods or algorithms described in connection with the embodiments of the present disclosure may be implemented directly in hardware, a software module executed by a processor, or a combination thereof. The software module may be placed in a random-access memory (RAM), a memory, a read-only memory (ROM), an electrically programmable ROM, an electrically erasable programmable ROM, a register, a hard disk, a removable magnetic disk, a CD-ROM, or any other form of storage medium known in the art.

The above description of the disclosed embodiments enables those skilled in the art to implement or use the present disclosure. Various modifications to these embodiments will be readily apparent to those skilled in the art, and the general principles defined in the present disclosure may be implemented in other embodiments without departing from the spirit or scope of the present disclosure. Therefore, the present disclosure will not be limited to the embodiments shown in the present disclosure, but is to be accorded the widest scope consistent with the principles and novel features of the present disclosure.

1. A data large-screen page processing method, comprising:
obtaining a to-be-colored data large-screen page, component information of the to-be-colored data large-screen page, and a preset color palette, wherein the to-be-colored data large-screen page comprises one or more to-be-colored components, the component information comprises a component type of each to-be-colored component, and the preset color palette comprises one or more basic colors;
determining a target color of a target component based on a component type of the target component, wherein the target component is one of the to-be-colored components comprised in the to-be-colored data large-screen page, and the target color is determined based on one or more colors selected from a group consisting of the preset color palette and a background color of the to-be-colored data large-screen page; and
coloring the target component with the target color to obtain a colored data large-screen page.

2. The method according to claim 1, wherein the component type of the target component is a category-type component, the category-type component comprises text of a plurality of contents, the category-type component is a component that uses different colors to represent text of different content, the component information of the to-be-colored data large-screen page further comprises a plurality of texts comprised in each category-type component, and the determining the target color of the target component based on the component type of the target component comprises:
obtaining a plurality of texts comprised in the target component from the component information of the to-be-colored data large-screen page; and
determining the target color corresponding to text of each content of the target component, wherein the target color is obtained based on the preset color palette.

3. The method according to claim 2, wherein the determining the target color corresponding to text of each content of the target component comprises:
determining, from the to-be-colored data large-screen page, a coloring area of a target text and an adjacent area of the coloring area, wherein the target text is one of the plurality of texts comprised in the target component;
calculating a first metric value of each first candidate color, wherein the first candidate color is determined according to the preset color palette, and the first metric value of the first candidate color is calculated according to one or more of a group consisting of a harmony between the first candidate color and a color of the adjacent area, a distinction between the first candidate color and the color of the adjacent area, and a continuity between the first candidate color and the color of the adjacent area; and
using a first candidate color with a highest first metric value as the target color corresponding to the target text.

4. The method according to claim 3, further comprising:
establishing a correspondence between the target text and the target color.

5. The method according to claim 4, wherein the determining the target color corresponding to text of each content of the target component comprises:
querying to obtain a target color corresponding to each text comprised in the target component.

6. The method according to claim 1, wherein the target color is a basic color of the preset color palette, or an extended color, wherein the extended color is obtained by mixing a plurality of basic colors comprised in the preset color palette, or is obtained by adjusting a brightness of a basic color comprised in the preset color palette.

7. The method according to claim 1, wherein the component type of the target component is a numerical-type component, the numerical-type component comprises data of a plurality of numerical values, the numerical-type component is a component that uses color shades to represent numerical changes of the data, the component information of the to-be-colored data large-screen page further comprises the numerical value of the data of each numerical-type component, and the determining the target color of the target component based on the component type of the target component comprises:
calculating a brightness of each second candidate color and a difference degree between each second candidate color and the background color, wherein the second candidate color is a color determined according to the preset color palette;
calculating a second metric value of each second candidate color by using the brightness and the difference degree;
determining an extreme color according to the second metric value of each second candidate color, wherein the extreme color corresponds to an extreme value data comprised in the numerical-type component, and the extreme value data is obtained from the component information of the to-be-colored data large-screen page; and
determining a third candidate color of data other than the extreme value data comprised in the numerical-type component according to the extreme color, wherein a brightness of the third candidate color is less than a brightness of the extreme color, and the third candidate color and the extreme color belong to a same color system.

8. The method according to claim 7, wherein the extreme value data comprised in the numerical-type component comprises median data, and the method further comprises:
using a neutral color as a color corresponding to the median data.

9. The method according to claim 7, wherein the extreme value data comprised in the numerical-type component does not comprise median data, two extreme colors are determined, and a hue difference between the two extreme colors is within a preset range.

10. The method according to claim 1, wherein the component type of the target component is a decorative-type component, the decorative-type component is a component with a decorative effect, the component information of the to-be-colored data large-screen page further comprises an initial color of each decorative-type component, and the determining the target color of the target component based on the component type of the target component comprises:
obtaining the initial color of the decorative-type component from the component information of the to-be-colored data large-screen page; and
determining the target color according to the initial color and the basic color comprised in the preset color palette.

11. The method according to claim 10, wherein the initial color comprises an initial main color and an initial secondary color, and the determining the target color according to the initial color and the basic color comprised in the preset color palette comprises:
calculating a color difference between the initial main color and the initial secondary color; and
calculating a target secondary color by using a target main color and the color difference, wherein the target main color is determined based on the preset color palette, the target main color is the target color corresponding to the target component with the color of the initial main color, and the target secondary color is the target color corresponding to the target component with the color of the initial secondary color.

12. The method according to claim 1, wherein the component type of the target component is a background-type component, the background-type component is a component that constitutes a background of the to-be-colored data large-screen page, and the determining the target color of the target component based on the component type of the target component comprises:
calculating a distinction between each fourth candidate color and the background color, wherein the fourth candidate color is a neutral color; and
selecting a fourth candidate color with the distinction greater than a distinction threshold as the target color of the target component.

13. (canceled)

14. An electronic device, comprising:
one or more processors; and
a storage apparatus, configured to store one or more programs,
wherein the one or more programs, when executed by the one or more processors, cause the one or more processors to implement a data large-screen page processing method, wherein the data large-screen page processing method comprises:
obtaining a to-be-colored data large-screen page, component information of the to-be-colored data large-screen page, and a preset color palette, wherein the to-be-colored data large-screen page comprises one or more to-be-colored components, the component information comprises a component type of each to-be-colored component, and the preset color palette comprises one or more basic colors;
determining a target color of a target component based on a component type of the target component, wherein the target component is one of the to-be-colored components comprised in the to-be-colored data large-screen page, and the target color is determined based on one or more colors selected from a group consisting of the preset color palette and a background color of the to-be-colored data large-screen page; and
coloring the target component with the target color to obtain a colored data large-screen page.

15. A computer-readable medium, configured to store a computer program, wherein the computer program, when executed by a processor, implements a data large-screen page processing method, wherein the data large-screen page processing method comprises:
obtaining a to-be-colored data large-screen page, component information of the to-be-colored data large-screen page, and a preset color palette, wherein the to-be-colored data large-screen page comprises one or more to-be-colored components, the component information comprises a component type of each to-be-colored component, and the preset color palette comprises one or more basic colors;
determining a target color of a target component based on a component type of the target component, wherein the target component is one of the to-be-colored components comprised in the to-be-colored data large-screen page, and the target color is determined based on one or more colors selected from a group consisting of the preset color palette and a background color of the to-be-colored data large-screen page; and
coloring the target component with the target color to obtain a colored data large-screen page.

16. The electronic device according to claim 14, wherein the component type of the target component is a category-type component, the category-type component comprises text of a plurality of contents, the category-type component is a component that uses different colors to represent text of different content, the component information of the to-be-colored data large-screen page further comprises a plurality of texts comprised in each category-type component, and the determining the target color of the target component based on the component type of the target component comprises:
obtaining a plurality of texts comprised in the target component from the component information of the to-be-colored data large-screen page; and
determining the target color corresponding to text of each content of the target component, wherein the target color is obtained based on the preset color palette.

17. The electronic device according to claim 16, wherein the determining the target color corresponding to text of each content of the target component comprises:
determining, from the to-be-colored data large-screen page, a coloring area of a target text and an adjacent area of the coloring area, wherein the target text is one of the plurality of texts comprised in the target component;
calculating a first metric value of each first candidate color, wherein the first candidate color is determined according to the preset color palette, and the first metric value of the first candidate color is calculated according to one or more of a group consisting of a harmony between the first candidate color and a color of the adjacent area, a distinction between the first candidate color and the color of the adjacent area, and a continuity between the first candidate color and the color of the adjacent area; and
using a first candidate color with a highest first metric value as the target color corresponding to the target text.

18. The electronic device according to claim 17, further comprising:
establishing a correspondence between the target text and the target color.

19. The electronic device according to claim 18, wherein the determining the target color corresponding to text of each content of the target component comprises:
querying to obtain a target color corresponding to each text comprised in the target component.

20. The electronic device according to claim 14, wherein the target color is a basic color of the preset color palette, or an extended color, wherein the extended color is obtained by mixing a plurality of basic colors comprised in the preset color palette, or is obtained by adjusting a brightness of a basic color comprised in the preset color palette.

21. The electronic device according to claim 14, wherein the component type of the target component is a numerical-type component, the numerical-type component comprises data of a plurality of numerical values, the numerical-type component is a component that uses color shades to represent numerical changes of the data, the component information of the to-be-colored data large-screen page further comprises the numerical value of the data of each numerical-type component, and the determining the target color of the target component based on the component type of the target component comprises:
calculating a brightness of each second candidate color and a difference degree between each second candidate color and the background color, wherein the second candidate color is a color determined according to the preset color palette;
calculating a second metric value of each second candidate color by using the brightness and the difference degree;
determining an extreme color according to the second metric value of each second candidate color, wherein the extreme color corresponds to an extreme value data comprised in the numerical-type component, and the extreme value data is obtained from the component information of the to-be-colored data large-screen page; and
determining a third candidate color of data other than the extreme value data comprised in the numerical-type component according to the extreme color, wherein a brightness of the third candidate color is less than a brightness of the extreme color, and the third candidate color and the extreme color belong to a same color system.
